(19) United States
(12) Patent Application Publication
(10) Pub. No.: US 2010/0253100 A1
(43) Pub. Date: Oct. 7, 2010

(54) DOOR HANDLE

(76) Inventor: DER-YUH CHERN, Pingtung City (TW)

Correspondence Address: LEONG C LEI, PMB # 1008, 1867 YGNACIO VALLEY ROAD, WALNUT CREEK, CA, 94598, US

(21) Appl. No.: 12/416,169

(22) Filed: Apr. 1, 2009

(51) Int. Cl. E05B 3/00

(52) U.S. Cl. 292/336.3

(57) ABSTRACT

The door handle contains a positioning element, an engaging ring, and a handle member. The positioning element is flat and substantially rectangular with four rounded corners. Four notches are formed besides the four corners, respectively. The inner circumference of the engaging ring is divided equally into four arc sections, each having a J-shaped track. Along the outer circumference of the engaging ring, a curved slot where an elastic plate is embedded and a neighboring axial groove are provided. After the positioning element is fixed to a lock on a door, the engaging ring and a first cover of the handle member are sleeved over the positioning element. By twisting the first cover which in turn rotates the engaging ring, the four corners follow the J-shaped tracks and are thus locked and the elastic plate is embedded into one of the notches.

### TECHNICAL FIELD OF THE INVENTION

The present invention generally relates to door handles, and more particularly to an easy-to-assemble, appealing, and secure door handle.

### DESCRIPTION OF THE PRIOR ART

A conventional door handle has a pair of symmetric inner and outer pieces with relevant elements inside for fixing the pieces to a lock member on a door and, then by twisting either the inner or outer piece, the door is opened or closed. Traditionally, the door handles are bulky and not appealing. The installation of a door handle is also quite complicated and the door handle could often be broken loosed by brute force. In other words, the door handles are not as secure as people expect.

### SUMMARY OF THE INVENTION

Accordingly, the present invention provides a novel door handle that is easy-to-assemble, appealing, and secure.

The door handle contains a positioning element, an engaging ring, and a handle member. The positioning element is flat and substantially rectangular with four rounded corners. Four notches are formed besides the four corners, respectively. The inner circumference of the engaging ring is divided equally into four arc sections, each having a J-shaped track. Along the outer circumference of the engaging ring, a curved slot where an elastic plate is embedded and a neighboring axial groove are provided. After the positioning element is fixed to a lock on a door, the engaging ring and a first cover of the handle member are sleeved over the positioning element. By twisting the first cover which in turn rotates the engaging ring, the four corners follow the J-shaped tracks and are thus locked and the elastic plate is embedded into one of the notches.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing a door handle according to an embodiment of the present invention.

FIG. 2 is a perspective break-down diagram showing an engaging ring of the door handle of FIG. 1.

FIG. 3 is a perspective diagram showing the assembly of the door handle of FIG. 1 to a door.

FIG. 4 is an axial-view diagram showing the engaging ring of the door handle of FIG. 1.

FIG. 5 is an axial-view showing a scenario of the interaction of the engaging ring and a positioning element of the door handle of FIG. 1.

FIG. 6 is an axial-view showing another scenario of the interaction of the engaging ring and the positioning element of the door handle of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

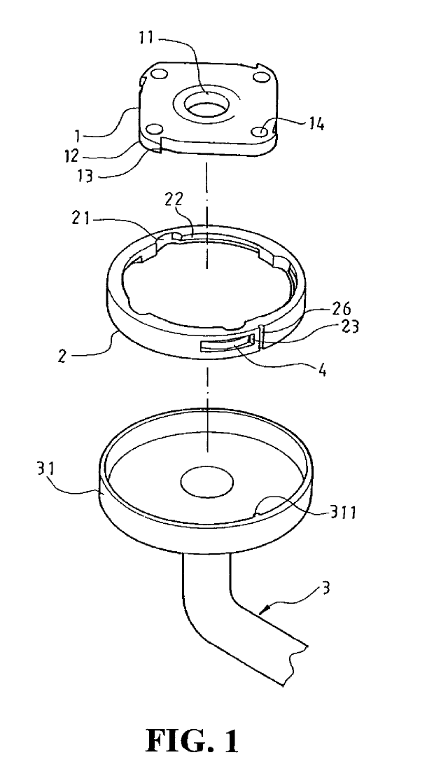

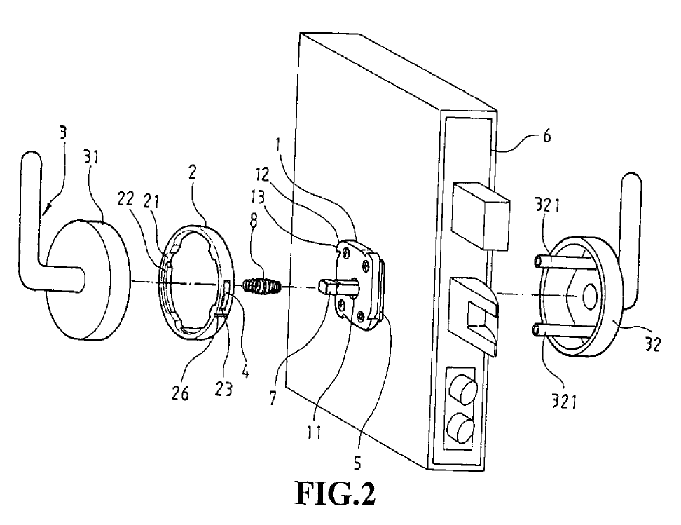

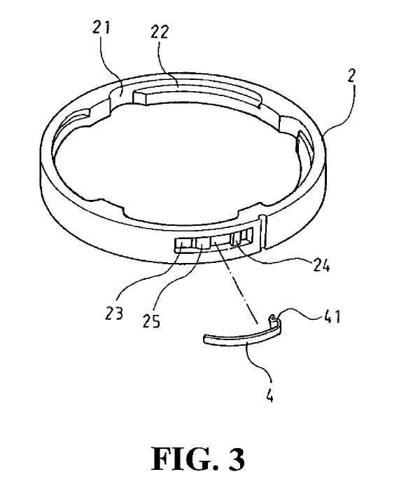

Please refer to FIGS. 1 and 2, along with FIG. 3. A door handle according to an embodiment of the present invention contains a positioning element 1, an engaging ring 2, and a handle member 3. The positioning element 1 is flat and substantially rectangular with a center through hole 11 and four rounded corners 12. The positioning element 1 has four bolt holes 14 adjacent to the four corners 12, respectively. The circumference of the positioning element 1 is chipped to form four notches 13 besides the four corners 12, respectively.

The inner circumference of the engaging ring 2 is divided equally into four arc sections. Each arc section has a curved indentation 21. Further in each curved indentation 21, there is a step 22 whose height is roughly half of that of the curved indentation 21 extending from an end of the curved indentation 21 to a point close to the other end. As such, a J-shaped track is actually formed inside each arc sections. Along the outer circumference of the engaging ring 2, there is a curved slot 23 within which a first axial column 24 and a second axial column 25 are provided. Also on the outer circumference of the engaging ring 2 and adjacent to the curved slot 23 is an axial groove 26.

The handle member 3 contains a first piece and a second piece. The first piece contains an L-shaped handle bar (not numbered) whose one end is joined to the center of an outer side of a flat cylindrical first cover 31. Similarly, the second piece contains an L-shaped handle bar (not numbered) whose one end is joined to the center of an outer side of a flat cylindrical second cover 32. Along the inner wall of the first cover 31, an axial rib 311 is provided. When the engaging ring 2 is positioned inside the first cover 31, it is immediately positioned by aligning and embedding the axial rib 311 into the axial groove 26. The second cover 32 has two axial poles 321 extending axially inward.

A slim elastic plate 4 has a bended first end 41 which is used to wind around the first column 24 while a part of the rest of the elastic plate 4 is against the second axial column 25 and a free second end (not numbered) sticks outward.

The door handle is assembled as follows. The positioning element 1 is first bolted to a lock 6 by two opposing bolt holes 14. A spring 5 is sandwiched between the positioning element 1 and the lock 6. The poles 321 of the second piece then are threaded through the other two opposing bolt holes 14 of the positioning element 1. Then bolts are applied to lock both the positioning element 1 and the second piece fixedly together. A spindle 7 is positioned to penetrate the center through hole 11 of the positioning element 1 and a spring 8 is sleeved over the spindle 7. Finally, the engaging ring 2 and the first piece are affixed to the positioning element 1.

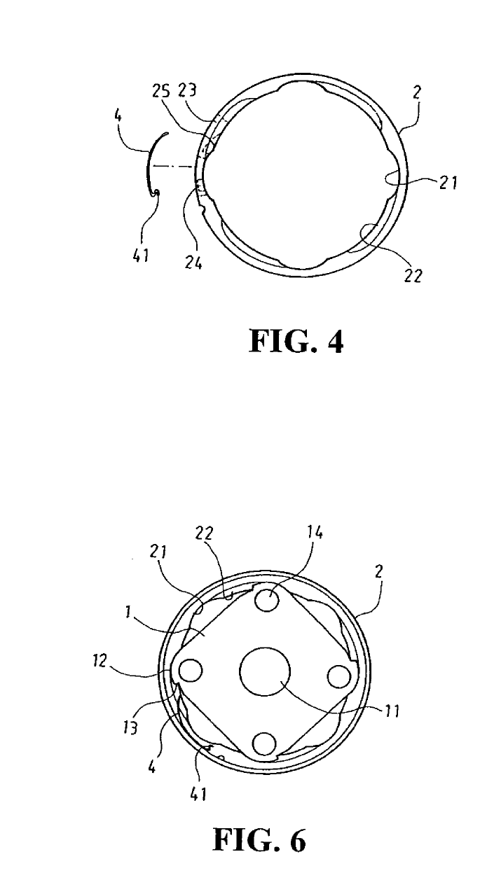

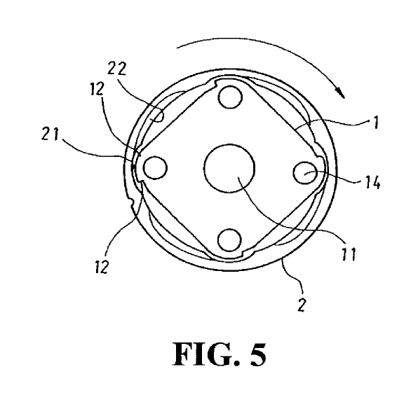

As shown in FIGS. 4 to 6, the four curved indentations 21 of the engaging ring 2 are configured to form a larger area so as to allow the accommodation of the four corners 12 of the positioning element 1. Then, by twisting the first cover 31 of the first piece which in turn rotates the engaging ring 2, the four corners 12 follow the J-shaped tracks and are thus locked by the steps 22.

By continuing twisting the first cover 31 and, therefore, the engaging ring 2, the free second end of the elastic plate 4 eventually is embedded into one of the notches 13 of the positioning element 1. As such, the first cover 31 cannot be easily twisted toward the opposite direction to disassemble the door handle of the present invention.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A door handle, comprising:
a flat and substantially rectangular positioning element having four rounded corners, a center through hole, and four notches along the circumference of said positioning element adjacent to said four comers, respectively;
an engaging ring, the inner circumference of said engaging ring divided equally into four arc sections, each having a curved indentation, each curved indentation having a step whose height is roughly half of that of said curved indentation extending from an end of said curved indentation to a point close to the other end of said curved indentation, thereby forming a J-shaped track, a slim elastic plate having a first end fixedly attached to the circumference of said engaging ring;
a handle member having at least a first piece, said first piece having a cylindrical first cover and a handle attached to an outer side of said first cover;
wherein, said positioning element is fixed to a lock of a door; said engaging ring are placed inside said first piece; said engaging ring and said first piece are twisted and locked to said positioning element as said four corners of said positioning element enter said curved indentations and slide into said tracks, respectively, and a free second end of said elastic plate embeds into one of said four notches.

2. The door handle according to claim 1, wherein said curved indentations of said engaging ring jointly form an area larger than said positioning element.

3. The door handle according to claim 1, wherein a curved slot is provided along the outer circumference of said engaging ring; and, inside said curved slot; a first axial column and a second axial column are provided to the positioning of said elastic plate.

4. The door handle according to claim 3, wherein said first end of said elastic plate is bended to wind around said first axial column inside said curved slot; and a part of said elastic plate is against said second axial column.

5. The door handle according to claim 1, wherein an axial groove is provided along the outer circumference of said engaging ring; an axial rib is provided along the inner wall of said first cover; and, when said engaging ring is placed inside said first cover by aligning and embedding said axial rib into said axial groove.
